(19) United States
(12) Patent Application Publication
(10) Pub. No.: US 2015/0030942 A1
(43) Pub. Date: Jan. 29, 2015

(54) CREW REST POWERED BY A FUEL CELL SYSTEM

(71) Applicant: Driessen Aerospace Group N.V., RL Alkmaar (NL)

(72) Inventors: Adriaan Eijkelenboom, KN Schoohoven (NL); Andreas Metz, Dillenburg (DE); Lucas Nastase, Lahnau (DE); Robert Ratliff, Buena Park, CA (US)

(73) Assignee: Driessen Aerospace Group N.V., RL Alkmaar (NL)

(21) Appl. No.: 14/384,296

(22) PCT Filed: Mar. 13, 2013
(86) PCT No.: PCT/IB2013/051993

§ 371 Date: Sep. 10, 2014

Related U.S. Application Data
(60) Provisional application No. 61/610,025, filed on Mar. 13, 2012.
(60) Provisional application No. 61/612,500, filed on Mar. 19, 2012.
(60) Provisional application No. 61/734,645, filed on Dec. 7, 2012.

(51) Int. Cl. H01M 8/04; B64D 41/00; B64D 11/00

(52) U.S. Cl. CPC H01M 8/04067; B64D 11/00; B64D 41/00; B64D 2011/0076; B64D 2041/005
USPC 429/410; 429/50; 429/400

(57) ABSTRACT

Disclosed are crew rests that may be powered by the outputs of a fuel cell system or other suitable power source. For example, but not limited to, a combination of the water, oxygen-depleted air, thermal energy and/or electrical energy generated by the fuel cell system may be used to supply the crew rest with its various power and water needs, helping to make the crew rest autonomous from the aircraft's main power systems.

### CROSS REFERENCE TO RELATED APPLICATIONS

This application claims priority benefits from (1) U.S. Provisional Application Ser. No. 61/612,500 filed on Mar. 19, 2012 and titled “Lower Deck Mobile Crew Rest with a Fuel Cell,” (2) U.S. Provisional Application Ser. No. 61/610,025 filed on Mar. 13, 2012 and titled “Ideas Using a FC (Fuel Cell) for Galleys, Lavatories, and Toilet System,” and (3) U.S. Provisional Application Ser. No. 61/734,645 filed on Dec. 7, 2012 and titled “Galley and Lavatory and Other Power Consumer(s) Powered by a Fuel Cell,” the contents of all of which are incorporated herein by reference.

This application is related to International Application No. PCT/US2013/30638 filed on Mar. 13, 2013 and titled “Fuel Cell System Powered Lavatory,” the contents of which are also incorporated herein by reference.

### FIELD OF THE INVENTION

Systems and methods relate to crew rests powered by one or more fuel cell systems.

### BACKGROUND

Crew rests may be used on some aircraft to offer crew members a resting place on long haul flights. Alternatively, passenger seats may be used, although this means the seats are unavailable for paying customers and also means the crew does not have a comfortable place to sleep. When needed, lower deck mobile crew rests (LDMCRs) are sometimes installed in an aircraft when possible (i.e., the plane is large enough and there is no cargo in the cargo bay). When not needed, the LDMCR can be removed from the aircraft so the aircraft is able to accommodate more cargo.

Traditional LDMCRs are connected to the aircraft by way of a system port to the aircraft's systems. Electrical energy, data, communications and/or ventilation are brought through the system port into the LDMCR. The creation of such a port, however, is complex and costly and therefore is usually only done as part of building a new aircraft, as creating a system port on existing aircraft is considered drastic and too costly. Moreover, the energy needed for powering the LDMCR is traditionally provided by the ground power unit or the aircraft's power generation systems (e.g., the engines or the auxiliary power unit). These power generators produce noise and CO₂ emissions and require fossil fuels for operation. In addition, in some cases, the power must travel a long distance to reach the LDMCR, which can lead to power dissipation.

The relatively new technology of fuel cell systems combines a fuel source of compressed hydrogen with oxygen in the air to produce electrical energy as a main product. A fuel cell system has several outputs in addition to electrical power, and these other outputs often are not utilized and therefore become waste. For example, thermal power (heat), water and oxygen-depleted air (ODA) are produced as by-products. These by-products are far less harmful than CO₂ emissions from current aircraft power generation processes.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Disclosed is a crew rest, which may be fixed or mobile, that is powered by at least one output of a fuel cell system or other integral power source such that the crew rest is configured to operate independently of an aircraft's power generation systems. In some embodiments, the crew rest is powered by at least two of the fuel cell system's outputs, which may be electrical energy, thermal energy, water, or oxygen-depleted air. According to some embodiments, the fuel cell system is positioned within or proximate the crew rest and outputs of the fuel cell system are used to power and operate the crew rest, making the crew rest autonomous from the aircraft's main power systems.

Also disclosed is a method of using a fuel cell system to power a crew rest associated with an aircraft by directing water, electrical energy, thermal energy, and/or oxygen-depleted air generated by the fuel cell system to appropriate areas or consumers of the crew rest.

Also disclosed is a crew rest powered by a power source that is integrated with the crew rest such that the crew rest is configured to operate independently of an aircraft's power generation system.

### BRIEF DESCRIPTION OF THE DRAWINGS

The specification makes reference to the following appended figures, in which use of like reference numerals in different figures is intended to illustrate like or analogous components.

FIG. 1 is a schematic of a crew rest according to one embodiment of the invention.

FIG. 2 shows a schematic example of input elements that may be used for a fuel cell and the output elements (H₂O, electricity, oxygen depleted air (ODA), and heat).

### DETAILED DESCRIPTION

Disclosed herein are systems and processes for providing a crew rest or mobile crew rest (MCR) that is powered by a fuel cell system or other suitable power source that is independent of the aircraft's other power generation systems. When powered by an appropriate fuel cell system or other independent power source, the crew rest's operation can be made autonomous from the aircraft's electrical power system. As such, the disclosed crew rests are capable of being used on more aircrafts, including existing aircrafts that were not specifically configured to receive a crew rest, because the crew rest does not require connection to a system port for receipt of power from the aircraft's power generation system. In addition, the disclosed crew rests are more energy efficient than traditional crew rests that are powered by the aircraft's power system.

A fuel cell system is a device that converts chemical energy from a chemical reaction involving hydrogen or other fuel source and oxygen rich gas (e.g., air) into electrical energy. As shown in FIG. 2, along with the generated electrical energy, a fuel cell system produces water, thermal power (heat), and oxygen-depleted air (ODA) as by-products. As disclosed herein, some or all of the electrical energy, thermal energy, water, and ODA may be used to power a crew rest for use in an aircraft.

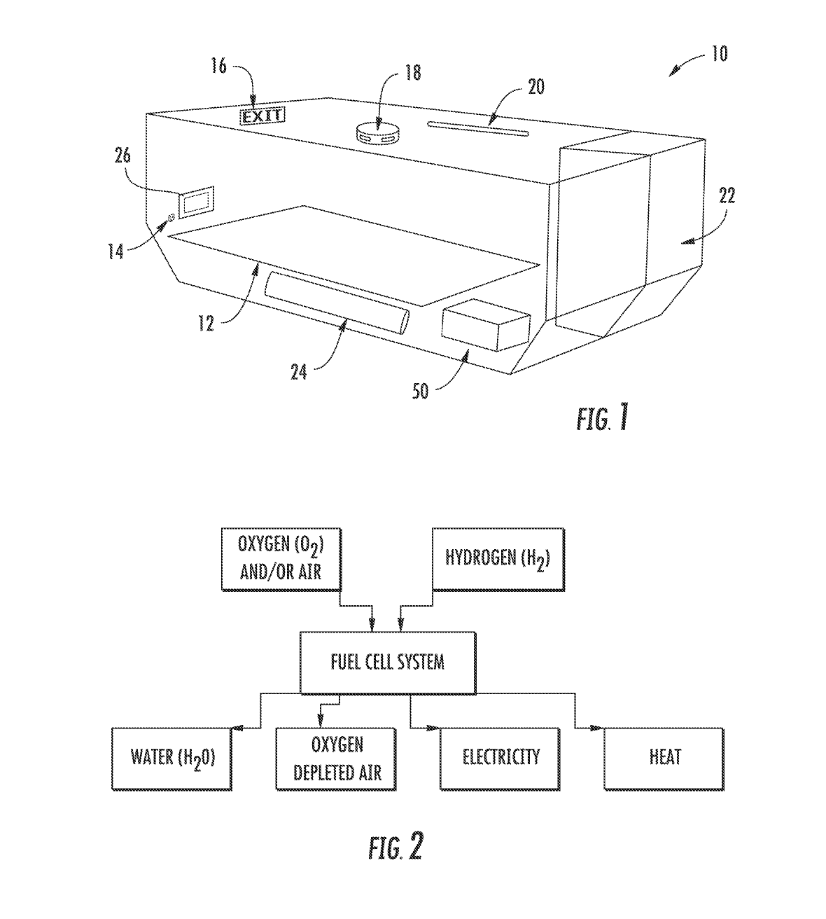

As shown in FIG. 1, a suitable fuel cell system, such as fuel cell system 50, may be stored within a crew rest, such as crew rest 10, or proximate the crew rest. By positioning the fuel cell system within or near the crew rest, the power is generated near the point of use and does not need to travel a long distance and therefore power dissipation is minimized

Any appropriate fuel cell system may be used, including, but not limited to, a Proton Exchange Membrane Fuel Cell (PEMFC), a Solid Oxide Fuel Cell (SOFC), a Molten Carbonate Fuel Cell (MCFC), a Direct Methanol Fuel Cell (DMFC), an Alkaline Fuel Cell (AFC), or a Phosphoric Acid Fuel Cell (PAFC). Any other existing fuel cell system or future fuel cell system technology, including but not limited to a hybrid solution, may also be used.

Based on typical power needs of the crew rest, it is contemplated that one fuel cell system is sufficient to power a crew rest, although more than one fuel cell system may be used if needed. The one or more fuel cell systems may be sized based on the energy/power requirements of the crew rest. Also, if the power requirements of the crew rest are more than can be supplied by one or more fuel cell systems, supplemental power may be supplied directly by any suitable energy electrical energy storage (such as, but not limited to, batteries or supercapacitors, etc.) that may be charged by power generated from a fuel cell system or otherwise.

In some embodiments, the fuel cell system optionally may include, among other things, ancillaries such as a battery system, a capacitor bank, and/or a power management system to help reduce the required energy/power output of the fuel cell system by helping to efficiently absorb peak energy/power demands.

As shown in FIG. 1, crew rest 10 may include various features, such as, but not limited to, a sleeping area 12, one or more power outlets 14, emergency lighting 16, a fire extinguishing system 18, general lighting 20, a lavatory unit 22, and a heater 24. Other crew rest units may include additional or fewer features or elements. In some embodiments, lavatory unit 22 includes a toilet and a wash basin and may include a shower, bath tub, or any other desired feature.

Various conduits (which may be pipes, hoses, or other suitable lines) may connect the fuel cell system (such as fuel cell system 50) with the crew rest unit 10 and distribute the water to appropriate areas or consumers of the crew rest unit. For example, water may be directed from the fuel cell system to the lavatory unit 22 (and more particularly, to a faucet of a wash basin for hand or other washing, to the toilet, and/or to a shower, etc.). In some embodiments, an input conduit may be used to direct water from the fuel cell system into a tank for storage and an output conduit may be used to direct the stored water from the tank to the appropriate area(s) of the crew rest unit. In some embodiments, a tank is not used and water is directed directly from the fuel cell system to appropriate location(s) within the crew rest.

Depending on the location of the fuel cell system, a pump or other suitable mechanism may be used to distribute the water to the appropriate area(s) of the lavatory unit. For example, in some embodiments, the fuel cell system is positioned near the ground level of the crew rest for structural or other reasons, in which case a pump or other suitable mechanism may be used to move the water output from the fuel cell system to the desired locations within the crew rest. In some cases, the pump or other suitable mechanism may be powered using electrical energy generated from the fuel cell system. If the fuel cell system is positioned higher in the crew rest than the desired location, water may be directed to the desired locations within the crew rest by gravity. The fuel cell system may be positioned at any suitable location of the crew rest and is not limited to the arrangement as shown in FIG. 1.

In some embodiments, water directed to the wash basin that has been used may be recovered, treated with ultraviolet light or otherwise, and directed to the toilet. In some cases, water from the fuel cell system (or used water from the wash basin) is directed to a waste holding tank to flush any waste stored within.

If the aircraft is equipped with a system port to connect the crew rest with the rest of the aircraft, the fuel cell system may be connected with such port so that its outputs are in communication with the aircraft's main potable water tank. In this way, if the water generated from the fuel cell system is not sufficient to meet water needs in the lavatory unit 22, water from the aircraft's main water tank can be utilized as well. Also, surplus water generated from the fuel cell system may be directed into the aircraft's main potable water tank if desired. Hot water from the fuel cell system may be introduced into the main potable water tank to dilute (cool) the fuel cell system hot water to a suitable temperature and/or to heat the water already stored in the main potable water, depending on the volume involved.

A fuel cell system produces moisture as a by-product. A heat exchanger may be used to condense the moisture and recover water from it. The heat exchanger may also be used to cool the water so it is suitable for use for showering, hand washing, waste holding tank flushing, and the like. The water obtained from the fuel cell system is warm enough that, in some embodiments, the need for traditional water heaters that are used to heat water supplied to a lavatory for use in wash basins and/or showers is eliminated, which reduces costs and storage space requirements and conserves energy. If used, the heat exchanger may include controls so that the hot water recovered from the fuel cell system may be cooled to the appropriate and/or desired temperature.

Once the water has been recovered from the moisture, it optionally may be directed into a storage tank as explained above and/or it may be further treated. For example, the water may be subjected to ultraviolet light to destroy any pathogens in the water. Alternatively or additionally, the water may be treated with chlorine, filtered, or otherwise processed to remove bacteria or other pathogens.

Another by-product of the fuel cell system is oxygen-depleted air (ODA). In some cases, the ODA as produced by the fuel cell system contains moisture, and a condenser or other suitable mechanism may be used to remove the moisture or otherwise dry the ODA before use. As one non-limiting example, the ODA may be used in the crew rest to inflate mattresses in the sleeping area 12 so that each occupant is capable of adjusting the firmness of his particular mattress (not illustrated) by either pumping in more air or letting out air. Any suitable number of mattresses/beds may be used in sleeping area 12. In addition, the mattresses may be standard mattresses instead of inflatable ones. In some embodiments, sleeping area 12 is smaller or larger than that indicated in FIG. 1. In some embodiments, sleeping area 12 includes one or more bunk beds.

The electrical energy generated by the fuel cell system may be used to power one or more power outlets 14, which in turn may be connected to an in-flight entertainment system (such as in-flight entertainment system 26) if desired. The power outlets may also be used to power any other desired electrical devices.

The electrical energy generated by the fuel cell system also may be used to power emergency lighting 16 and/or general lighting 20. The electrical energy generated by the fuel cell system may further be used to power a fire extinguishing system 18. The fire extinguishing system then may be used to detect smoke and alert the occupants of the crew rest that smoke has been detected. In addition, once the occupants have been evacuated, the electrical energy of the fuel cell system may be used to power a fire extinguishing system capable of emitting an extinguishing gas.

The electrical and/or thermal energy generated from the fuel cell system may be used to power a heater 24, which in some embodiments is a heat pipe that combines the principles of thermal conductivity and phase transition to efficiently manage the transfer of heat between two solid interfaces. Other suitable heaters may also be used. In some cases, the thermal energy alone is used to heat the crew rest.

Each of the fuel cell system by-products described above may be used alone or in combination with other by-products or other power sources to meet various needs of the crew rest and its occupants.

Using a fuel cell system to power a crew rest as described above may reduce noise and CO₂ emissions. In some embodiments, some or all of the by-products of the fuel cell system are utilized to power the fuel cell system, thus increasing the efficiency of the fuel cell system and improving its power to weight ratio. In addition, by using a fuel cell system to power the crew rest, less fossil fuels are needed and the crew rest is essentially energy independent so that need for a system port to the aircraft is minimized or eliminated, as discussed above. Specifically, the need for data/communication with the aircraft may be achieved by wireless connection, and the need for ventilation may be achieved by using a connection directly to the outside of the crew rest. In some embodiments, a filter may be used to clean incoming air. In addition, by equipping the crew rest with a lavatory unit powered by a fuel cell system, the aircraft crew is able to use a restroom that is separate from the ones used by commercial passengers.

The foregoing is provided for purposes of illustrating, explaining, and describing embodiments of the invention. Further modifications and adaptations to these embodiments will be apparent to those skilled in the art and may be made without departing from the scope or spirit of the invention. As one example, instead of a fuel cell system, another suitable power source that is independent from the aircraft's main power system may be used.

1. A crew rest powered by a power source that is integral with the crew rest such that the crew rest is configured to operate independently of an aircraft's power generation system.

2. The crew rest of claim 1, wherein the power source is a fuel cell system.

3. The crew rest of claim 2, wherein one or more outputs of the fuel cell system is supplied to the crew rest and wherein the one or more outputs comprises electrical energy, thermal energy, water, or oxygen-depleted air.

4. The crew rest of claim 2, wherein all of the one or more outputs are used within the crew rest.

5. The crew rest of claim 1, wherein the crew rest is mobile.

6. A crew rest powered by at least one output of a fuel cell system such that the crew rest is configured to operate independently of an aircraft's power generation system, wherein the at least one output comprises electrical energy, thermal energy, water, or oxygen-depleted air.

7. The crew rest of claim 6, wherein at least two of the outputs of the fuel cell system are supplied to the crew rest.

8. The crew rest of claim 6, wherein the fuel cell system is contained within or is proximate the crew rest and wherein the water produced by the fuel cell system is directed by at least one conduit to appropriate areas of the crew rest or to consumers within the crew rest.

9. The crew rest of claim 8, further comprising a heat exchanger that cools the water produced by the fuel cell system before or after the water is directed to the appropriate areas or consumers.

10. The crew rest of claim 8, wherein the fuel cell system is positioned higher than the appropriate areas or consumers of the crew rest so that the water is directed by gravity along the at least one conduit to the appropriate areas or consumers.

11. The crew rest of claim 8, wherein the water produced by the fuel cell system is treated before or after it is directed by the at least one conduit.

12. The crew rest of claim 6, wherein the oxygen-depleted air from the fuel cell system is directed to appropriate areas of the crew rest or consumers of the crew rest.

13. The crew rest of claim 6, wherein the electrical energy from the fuel cell system is used to power one or more electrical outlets.

14. The crew rest of claim 6, wherein the electrical energy from the fuel cell system is used to power a fire extinguishing system.

15. The crew rest of claim 6, wherein the electrical energy from the fuel cell system is used to illuminate at least portions of the crew rest.

16. The crew rest of claim 6, wherein at least one of the electrical energy or the thermal energy from the fuel cell system is used to heat the crew rest.

17. A method of using a fuel cell system to power a crew rest associated with an aircraft such that the crew rest is configured to operate independently of an aircraft's power generation system, the method comprising at least one of the following:
directing water supplied by the fuel cell system to appropriate areas of the crew rest or to consumers of the crew rest;
directing heat generated by the fuel cell system to appropriate areas of the crew rest or to consumers of the crew rest;
directing power generated by the fuel cell system to appropriate areas of the crew rest or to consumers of the crew rest; and
directing oxygen-depleted air generated by the fuel cell system to appropriate areas of the crew rest or to consumers of the crew rest.

18. The method of claim 17, wherein the fuel cell system is positioned within the crew rest such that gravity directs the water to the appropriate areas or consumers.

19. The method of claim 17, further comprising using the oxygen-depleted air to inflate one or more mattresses for use in the crew rest.

20. The method of claim 17, further comprising treating the water before or after it is directed to the appropriate areas or consumers.
